(19) United States
(12) Patent Application Publication
(10) Pub. No.: US 2025/0172910 A1
(43) Pub. Date: May 29, 2025

(54) STUD-HOLDER FOR A HOROLOGICAL REGULATING MEMBER COMPRISING A STUD FITTED WITH AN ANTI-JAMMING ARM

(71) Applicant: ETA SA MANUFACTURE HORLOGÈRE SUISSE, Grenchen (CH)

(72) Inventors: Fabrice DELEVAUX, Les Bois (CH); Gael FEUSIER, Bévilard (CH)

(73) Assignee: ETA SA MANUFACTURE HORLOGÈRE SUISSE, Grenchen (CH)

(21) Appl. No.: 18/925,183

(22) Filed: Oct. 24, 2024

(30) Foreign Application Priority Data
Nov. 27, 2023 (EP) 23212383.6

(51) Int. Cl. G04B 17/32; G04B 17/06

(52) U.S. Cl. CPC G04B 17/325; G04B 17/063

(57) ABSTRACT

A stud-holder (1) for a regulating member (10) of a horological movement, the regulating member (10) including an inertial mass, for example a balance (23), a balance spring (25) including a strip (2) wound about itself in several turns, and a balance cock (22), the stud-holder (1) including a main body (31) intended to be mounted on the balance cock (42), and a stud (34) mounted on the main body (31) in a first direction, wherein the stud-holder (1) includes an arm (5) extending from the stud (34), the arm (5) being directed in a second direction under the main body (31), the second direction forming a non-zero angle with the first direction, so as to pass at least in part beneath a balance spring (25) held by the stud (34), when the stud-holder (1) is mounted on the regulating member (10).

### CROSS REFERENCE TO RELATED APPLICATION

This application claims priority to European Patent Application No. 23212383.6 filed Nov. 27, 2023, the entire contents of which are incorporated herein by reference.

### TECHNICAL FIELD OF THE INVENTION

The invention relates to the field of watchmaking, and more particularly to the field of mechanical watchmaking, where the regulation of the driving energy is provided by a regulating member.

The invention relates more specifically to a stud-holder for a horological regulating member comprising a stud provided with an anti-jamming arm, as well as to a regulating member comprising such a stud-holder, and to a horological movement comprising such a regulating member.

### TECHNOLOGICAL BACKGROUND

In most mechanical watches, the energy required to rotate the hands (for example the minute and hour hands) is stored in a barrel and then delivered by a sprung balance system, which comprises a flywheel called a balance, combined with a spring in the form of a spirally wound strip called a balance spring.

The rotation of the balance is maintained—and its oscillations counted—by an escapement mechanism comprising a pallet-lever animated by a low-amplitude oscillating motion, provided with two pallets which engage the teeth of an escape wheel. When the escape wheel is engaged in this way, it is caused to rotate in steps, the frequency of which rotation is determined by the frequency of oscillation of the pallet-lever, which is itself set to the frequency of oscillation of the sprung balance.

An inside end of the balance spring is attached to a staff that rotates as one with the balance; an outside end of the balance spring is attached to a stud mounted on a stud-holder that is itself rigidly connected to a stationary cock. A stud typically comprises a notch bounded by two walls. The outside end of the balance spring is held in the notch, for example by means of an adhesive.

However, in the event of an impact, one or more outside coils of the balance spring can pass underneath the stud and become jammed behind the stud.

This is because when the balance oscillates, the balance spring passes from a contracted configuration to an extended configuration, and vice-versa, in an operating plane of the balance spring. As a result, if an impact occurs, the balance spring can deform transversely to the operating plane, and have one or more outer coils which pass beneath the stud. As a result, the oscillation of the balance is disrupted by this jamming, which leads to a disruption to the rate of the regulating member, or even to it coming to a complete stop.

To avoid this phenomenon, stud-holders exist where the end of the stud is substantially conical, so that the coils slide along the cone and pass back under the stud, following the passage and jamming of one or more coils around the stud. The disruption to the rate of the regulating member lasts until the balance spring returns to its normal position.

Other stud-holders comprise studs with a longer wall on the balance spring side, in order to hinder the passage of the coils underneath the stud. However, this wall must be very close to the balance, which creates the risk of the balance hitting this wall during an impact, thus creating another disruption.

Nevertheless, these stud-holders are not satisfactory, as they do not completely eliminate this problem or create new problems.

### SUMMARY OF THE INVENTION

The aim of the present invention is to overcome some or all of the aforementioned drawbacks by providing a stud-holder which prevents the one or more outer coils of the balance spring from remaining jammed around the stud, particularly in the event of an impact.

To this end, the invention relates to a stud-holder for a regulating member of a horological movement, the regulating member comprising an inertial mass, for example a balance, a balance spring comprising a strip wound about itself in several turns, and a balance cock, the stud-holder comprising a main body intended to be mounted on the balance cock, and a stud mounted on the main body in a first direction.

The invention is characterised in that the stud-holder comprises an arm extending from the stud, the arm being directed in a second direction under the main body, the second direction forming a non-zero angle with the first direction, so as to pass at least in part beneath a balance spring held by a stud, when the stud-holder is mounted on the regulating member.

Thanks to the invention, the coils cannot pass underneath the stud and become jammed behind it.

This is because the arm retains the outer coils of the balance spring when they deform in a direction perpendicular to the plane of the balance spring.

Thus, the chronometric performance of the movement is not adversely affected by a distortion of the rate of the regulating member, if one or more coils are stuck behind the stud, or if the balance strikes the stud.

According to a particular embodiment of the invention, the second direction is substantially perpendicular to the first direction.

According to a particular embodiment of the invention, the stud comprises a notch intended to receive an outside end of the strip.

According to a particular embodiment of the invention, the notch comprises an inner wall and an outer wall, with the arm extending from the inner wall.

According to a particular embodiment of the invention, the arm is oriented radially towards the axis of the regulating member.

According to a particular embodiment of the invention, the main body comprises a radial member on which the stud is mounted.

According to a particular embodiment of the invention, the arm is elongated in a longitudinal direction.

According to a particular embodiment of the invention, the arm has the shape of a substantially flat tab.

According to a particular embodiment of the invention, the arm is intended to extend at least beyond the penultimate coil of the balance spring towards the centre of the balance spring, when the balance spring is in the extended configuration, preferably in the contracted configuration.

According to a particular embodiment of the invention, the inner wall is longer than the outer wall.

The invention further relates to a horological regulating member comprising an inertial mass, for example a balance, a balance spring comprising a strip wound about itself in several turns, and such a stud-holder.

The invention further relates to a horological movement comprising such a horological regulating member.

### BRIEF DESCRIPTION OF THE FIGURES

The purposes, advantages and features of the present invention will become apparent after reading several embodiments, which are provided for purposes of illustration only and not intended to limit the scope of the invention, given with reference to the accompanying drawings, wherein:

FIG. 1 diagrammatically shows a perspective top view of a regulating member comprising a stud-holder according to one embodiment of the invention,

FIG. 2 diagrammatically shows a top view of the regulating member shown in FIG. 1, without the balance cock,

FIG. 3 diagrammatically shows a perspective bottom view of the regulating member shown in FIG. 1,

FIG. 4 diagrammatically shows a bottom view of the regulating member shown in FIG. 1, without the balance cock, and

FIG. 5 diagrammatically shows an enlarged view of the pinning up of the balance spring to the stud of the regulating member shown in FIG. 1.

### DETAILED DESCRIPTION OF THE INVENTION

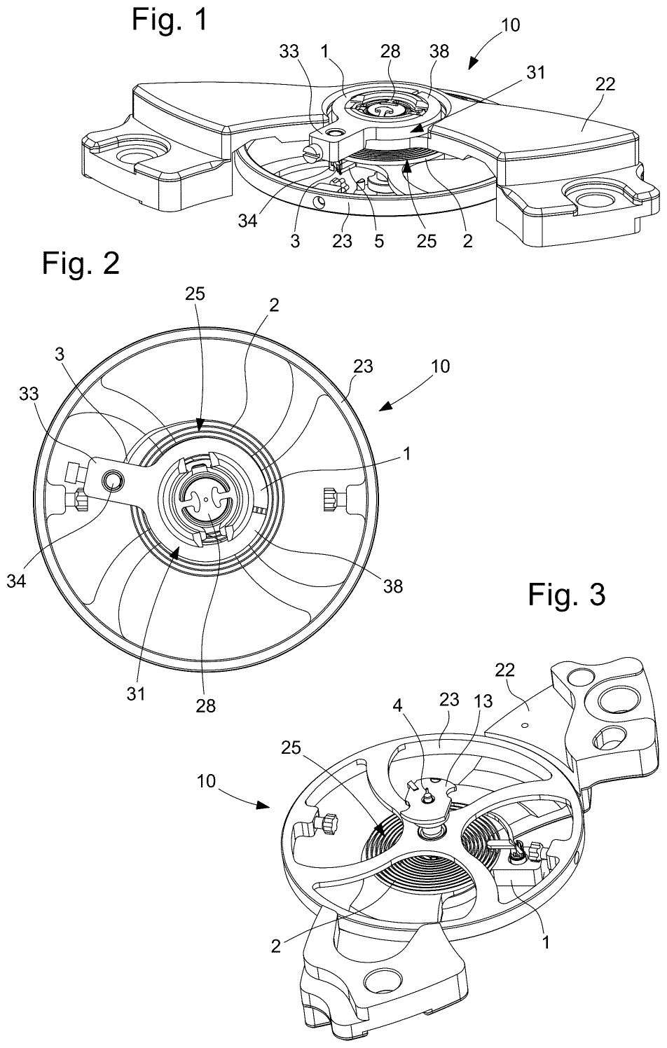

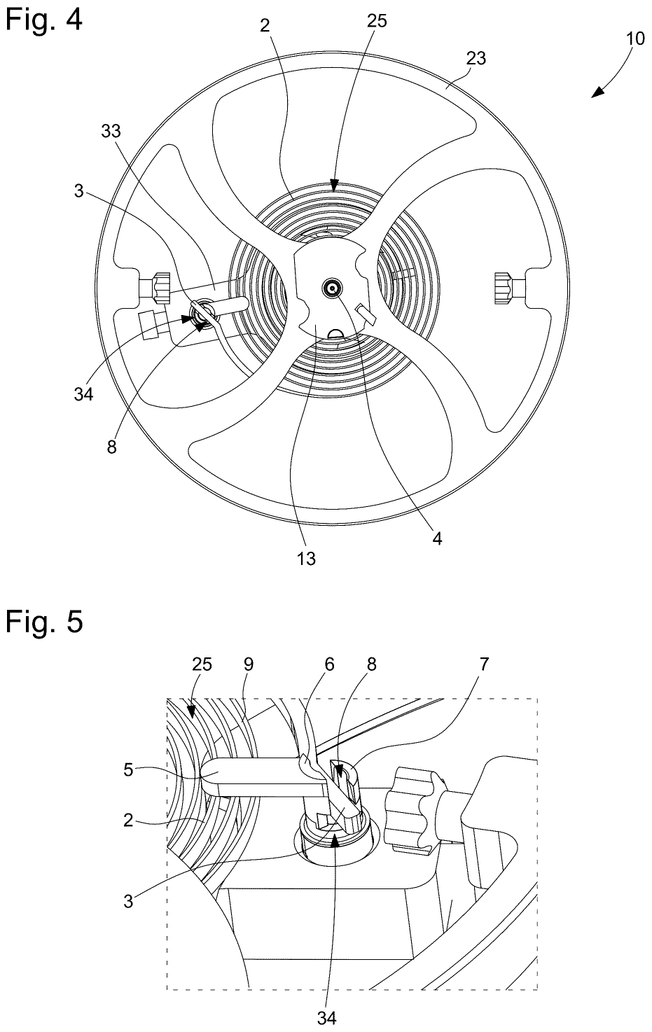

FIGS. 1 to 3 diagrammatically show part of an embodiment of a regulating member 10 comprising a stud-holder 1 according to the invention.

Such a regulating member 10 is intended to be arranged in a horological movement in order to regulate the rate of said movement. The escapement mechanism is not shown in the figures, nor is the horological movement.

The regulating member 10 comprises an inertial mass, in this case an annular balance 23, a balance spring 25 as a resilient return element for the inertial mass configured to cause it to oscillate, a balance staff 4, and a balance cock 22. The components are stacked from bottom to top in the following order: the balance 23, the balance spring 25 and the balance cock 22.

The balance staff 4 passes through the centre of the balance and of the balance spring 25. The balance staff 4 is held by two shock-resistant bearings 28 arranged at both ends of the balance staff 4. A first bearing, not shown in the figures, is arranged below the balance cock 22, and the second bearing 28 is arranged therein. The balance cock 22 has a through-hole inside which the second bearing 28 is held.

A plate 13 intended to cooperate with a pallet-lever of the escapement mechanism is arranged at the base of the balance staff 4.

The balance spring 25 preferably extends substantially in one plane. The balance spring 25 comprises a flexible strip 2 wound about itself in several turns, the strip 2 having a predefined stiffness. The inside end of the strip 2 is integral with or assembled with a rigid support, typically referred to as a collet, not shown in the figures. The rigid support is, for example, substantially triangular in shape and is threaded around the staff of the balance 4.

The regulating member 10 comprises a stud-holder 1 fitted with a stud 34 suspended from the end of a radial member 33. The stud-holder 1 is mechanically linked to the outside end 3 of the strip 2. The stud-holder 1 surrounds the second bearing 28. For this purpose, the stud-holder 1 comprises a central ring 38 arranged around the second bearing 28, and which rests on the balance cock 22. The radial member 33 extends radially relative to the central ring 38.

Moreover, the stud 34 is rigidly attached to the outside end 3 of the strip 2. In other words, the stud 34 is integral with the outside end 3 of the strip 2. The stud 34 and the balance spring 25 are assembled, for example, by bonding, brazing, welding, by deformation of metallic glass, or by mechanical fastening.

The stud 34 is movable relative to the balance cock 22. To this end, the stud-holder 1 can rotate about the second bearing 28. The stud-holder 1 can, for example, be displaced over an angular range of 10° or even 20°. The rate of the regulating member 10 can thus be adjusted.

The stud 34 is mounted on the main body 31 in a first direction, preferably substantially perpendicular to the plane of the main body 31, and/or to the operating plane of the balance spring.

According to the invention, the stud-holder 1 comprises an arm 5 extending from the stud 34, below the operating plane of the balance spring.

The arm 5 is directed in a second direction under the main body 31. The second direction forms a non-zero angle with the first direction, so as to pass at least partly under the balance spring 25 held by the stud 34. The arm 5 is oriented radially towards the axis of the regulating member and/or of the balance spring 25. The arm 5 is arranged at the free end of stud 34.

The second direction is preferably substantially perpendicular to the first direction.

In FIG. 5, the stud 34 comprises a notch 8 intended to receive an outside end 3 of the strip 2. The notch 8 has an inner wall 6 and an outer wall 7. Preferably, the inner wall 6 is longer than the outer wall 7. The arm 5 extends from the inner wall 6 towards the axis of the regulating member and/or of the balance spring 25. The arm 5 has the shape of a substantially flat tab. The arm 5 is elongated in a longitudinal direction.

When the stud-holder 1 is mounted on the regulating member 10, the arm 5 extends at least beyond the penultimate coil 9 of the balance spring from the outside towards the axis of the balance spring, when the balance spring 25 is in the extended configuration, preferably in the contracted or contracted resting configuration.

Preferably, the arm 5 extends at least beyond several of the last coils. This further increases protection against the risk of the last coils becoming jammed around the stud 34.

It goes without saying that the invention is not limited to the embodiments of regulating members described with reference to the figures and alternatives can be considered without leaving the scope of the invention.

1. A stud-holder for a regulating member (10) of a horological movement, the regulating member (10) comprising an inertial mass, for example a balance (23), a balance spring (25) comprising a strip (2) wound about itself in several turns, and a balance cock (22), the stud-holder (1) comprising a main body (31) intended to be mounted on the balance cock (42), and a stud (34) mounted on the main body (31) in a first direction, characterised in that the stud-holder (1) comprises an arm (5) extending from the stud (34), the arm (5) being directed in a second direction under the main body (31), the second direction forming a non-zero angle with the first direction, so as to pass at least in part beneath a balance spring (25) held by the stud (34), when the stud-holder (1) is mounted on the regulating member (10).

2. The stud-holder according to claim 1, wherein the second direction is substantially perpendicular to the first direction.

3. The stud-holder according to claim 1, wherein the stud (34) comprises a notch (8) intended to receive an outside end (3) of the strip (2).

4. The stud-holder according to claim 3, wherein the notch (8) comprises an inner wall (6) and an outer wall (7), with the arm (5) extending from the inner wall (6).

5. The stud-holder according to claim 1, wherein the arm (5) is oriented radially towards the axis of the regulating member (10).

6. The stud-holder according to claim 1, wherein the main body (31) comprises a radial member (33) on which the stud (34) is mounted.

7. The stud-holder according to claim 1, wherein the arm (5) is elongated in a longitudinal direction.

8. The stud-holder according to claim 1, wherein the arm (5) has the shape of a substantially flat tab.

9. The stud-holder according to claim 1, wherein the arm (5) is intended to extend at least beyond the penultimate coil (9) of the balance spring (25) towards the centre of the balance spring (25), when the balance spring (25) is in the extended position, preferably when it is in the contracted position.

10. The stud-holder according to claim 1, wherein the inner wall (6) is longer than the outer wall (7).

11. A regulating member for a horological movement, the regulating member (10) comprising an inertial mass, for example a balance (23), a balance spring (25) comprising a strip (2) wound about itself in several turns, wherein the regulating member further comprises the stud-holder (1) according to claim 1.

12. A horological movement, comprising the regulating member according to claim 11.
